(19) United States
(12) Patent Application Publication
(10) Pub. No.: US 2024/0078277 A1
(43) Pub. Date: Mar. 7, 2024

(54) COMPUTER IMPLEMENTED SYSTEMS, SOFTWARE, AND METHODS FOR SHARING GROUPS OF NEWS STORIES

(71) Applicant: Andrew Charles Walraven, Los Angeles, CA (US)

(72) Inventor: Andrew Charles Walraven, Los Angeles, CA (US)

(21) Appl. No.: 18/498,514

(22) Filed: Oct. 31, 2023

Related U.S. Application Data
(60) Provisional application No. 63/403,145, filed on Sep. 1, 2022.

(51) Int. Cl. G06F 16/954; G06F 16/955; G06F 16/957

(52) U.S. Cl. CPC G06F 16/954; G06F 16/955; G06F 16/9577

(57) ABSTRACT

The embodiments are directed to systems and methods for generating groups of news stories. A system for generating groups of news stories may include a processor and a memory. The memory may be coupled to the processor. The memory may include instructions configured to cause the processor to determine an article based on a topic. The memory may also include instructions configured to cause the processor to generate an article rank for the article based on an age of the article, a base rate of the article, and a bonus of the article. Additionally, the memory may include instructions configured to cause the processor to display the article based on the article rank being above a target rank.

### RELATED APPLICATIONS

This application claims priority to U.S. Provisional Application Ser. No. 63/403,145 filed Sep. 1, 2022 titled “METHOD AND SYSTEM FOR NEWS” which is incorporated herein in its entirety by reference.

### FIELD

The disclosure relates generally to the field of electronic online news services, specifically and not by way of limitation, some embodiments are related to following topics in electronic online news services.

### BACKGROUND

It has been found that 68% of American adults get their news from social media. Social networks are less than 20 years old from their initial launch. We have shifted our behavior to watching pet videos or browsing photos and memes because sharing news and information carries a lot of baggage. We refrain from sharing articles because what's interesting to us can be irrelevant, annoying, or even divisive to most of our social connections. It may not be fun anymore, but we still enjoy sharing news and information but have nowhere to go.

What may be desired is a way to connect with the communities that share our interests and to remove the divisive features that are adding little value but still create lots of noise and friction when all we want to do is share news and information with the people who share our passion on an event, issue or topic of interest.

### SUMMARY

In one example implementation, an embodiment includes a system for generating and sharing groups of news stories in accordance with the systems and methods described herein.

Disclosed are example embodiments of systems and methods for generating groups of news stories. A system for generating groups of news stories may include a processor and a memory. The memory may be coupled to the processor. The memory may include instructions configured to cause the processor to determine an article based on a topic. The memory may also include instructions configured to cause the processor to generate an article rank for the article based on the age of the article, a base rate of the article, and a bonus of the article. Additionally, the memory may include instructions configured to cause the processor to display the article based on the article rank being above a target rank.

In a first aspect, a computer system to generate groups of news stories defined as feeds for respective topics is provided. The system includes one or more hardware processors, associated memory, and associated visual display configured by machine-readable instructions. Execution of the machine readable instructions by the processor of the computer system to perform functions. The functions can be configured to: determine an article based on a topic; generate an article rank for the article based on an age of the article, a base rate of the article, and a bonus of the article; and display the article within one or more feeds on the visual display based on the article rank being above a target rank. The age of the article is based upon time. The base rate of the article may be based on user actions including one or more of clicks, votes, picks, bookmarks and shares. The bonus of the article may be based upon a busyness of a respective feed related to base rates of all articles within the respective feed.

Additionally and/or alternatively, the feeds comprise newsroom headlines, topic headlines, source headlines and/or trending headlines.

Additionally and/or alternatively, the user actions include one or more of clicking on an article, upvoting an article, downvoting an article, selecting an article as a pick-of-the-day, bookmarking an article, and sharing an article.

Additionally and/or alternatively, the age of the article is based upon at least one of a time when the article was written, and a time when the article was published.

Additionally and/or alternatively, displaying the article within one or more feeds includes displaying the article within a topic feed.

Additionally and/or alternatively, the one or more hardware processors, associated memory, and associated visual display are further configured by machine-readable instructions to: output a graphical user interface (GUI) including a trend surfing interface configured to present an arrangement of selectable topic links related to a trending topic, wherein the selectable topic links lead to articles related to the trending topic and based upon the generated article rank.

Additionally and/or alternatively, each of the selectable topic links includes a graphic related to the trending topic. A size of each graphic related to the trending topic may be scaled based upon a scaling factor related to the trending topic.

Additionally and/or alternatively, each of the selectable topic links includes an image from a latest posted article within the selectable topic link.

Another aspect is directed to a method to generate groups of news stories defined as feeds for respective topics, using one or more hardware processors, associated memory, and associated visual display configured by machine-readable instructions. The method includes: determining an article based on a topic; generating an article rank for the article based on an age of the article, a base rate of the article, and a bonus of the article; and displaying the article within one or more feeds on the visual display based on the article rank being above a target rank. The age of the article is based upon time. The base rate of the article may be based on user actions including one or more of clicks, votes, picks, bookmarks and shares. The bonus of the article may be based upon a busyness of a respective feed related to base rates of all articles within the respective feed.

Additionally and/or alternatively, the feeds comprise newsroom headlines, topic headlines, source headlines and/or trending headlines.

Additionally and/or alternatively, the user actions include one or more of clicking on an article, upvoting an article, downvoting an article, selecting an article as a pick-of-the-day, bookmarking an article, and sharing an article.

Additionally and/or alternatively, the age of the article is based upon at least one of a time when the article was written, and a time when the article was published.

Additionally and/or alternatively, displaying the article within one or more feeds includes displaying the article within a topic feed.

Additionally and/or alternatively, the method further includes outputting a graphical user interface (GUI) including a trend surfing interface configured to present an arrangement of selectable topic links related to a trending topic, wherein the selectable topic links lead to articles related to the trending topic and based upon the generated article rank.

Additionally and/or alternatively, each of the selectable topic links includes a graphic related to the trending topic. A size of each graphic related to the trending topic may be scaled based upon a scaling factor related to the trending topic.

Additionally and/or alternatively, each of the selectable topic links includes an image from a latest posted article within the selectable topic link.

The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principals involved and to enable a person skilled in the relevant art(s) to make and use the disclosed technologies.

FIG. 1 shows a schematic block diagram illustrating a communication system including generating groups of news stories capabilities on servers and mobile devices according to an embodiment of the present invention.

FIG. 2 is a schematic block diagram illustrating the components of a computing device (e.g. a mobile device) according to an embodiment of the present invention of FIG. 1.

FIG. 3 is a block diagram of a computing system configured for providing the generation of groups of news stories, in accordance with the example embodiments.

FIG. 4 is a flowchart illustrating the system and process architecture flowchart according to an embodiment of the present invention.

FIG. 5 illustrates an example trend surfing overview in accordance with the systems and methods described herein.

FIG. 6 illustrates an example trend navigator diagram in accordance with the systems and methods described herein.

FIG. 7 illustrates another example trend navigator diagram in accordance with the systems and methods described herein.

FIG. 8 illustrates an example of trend navigator layouts in accordance with the systems and methods described herein.

FIG. 9 illustrates an example of trend navigator alignments in accordance with the systems and methods described herein.

FIG. 10 illustrates an example of trend surfing workflow in accordance with the systems and methods described herein.

FIG. 11 illustrates another example of trend surfing workflow in accordance with the systems and methods described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of example systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using various components, hardware, electronic hardware, computer software, or any combination thereof. Whether such elements are implemented as hardware or software depends upon the particular application and design constraints imposed on the overall system.

As discussed above, embodiments of the present invention relate to the generation of groups of news stories defined as feeds for respective topics, and more particularly to a system, software (e.g. host platform, web application and mobile device application), and method, used to improve the generation of groups of news stories.

It is noted that, depending on the type of wireless communication system, a wireless communication device or mobile device, such as a smartphone, cellular telephone, two-way radio, personal digital assistant (PDA), personal computer (PC), laptop computer, home entertainment equipment, etc., communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system) and communicate over that channel or channels. For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

The present embodiments are generally directed to a system and method for generating groups of news stories.

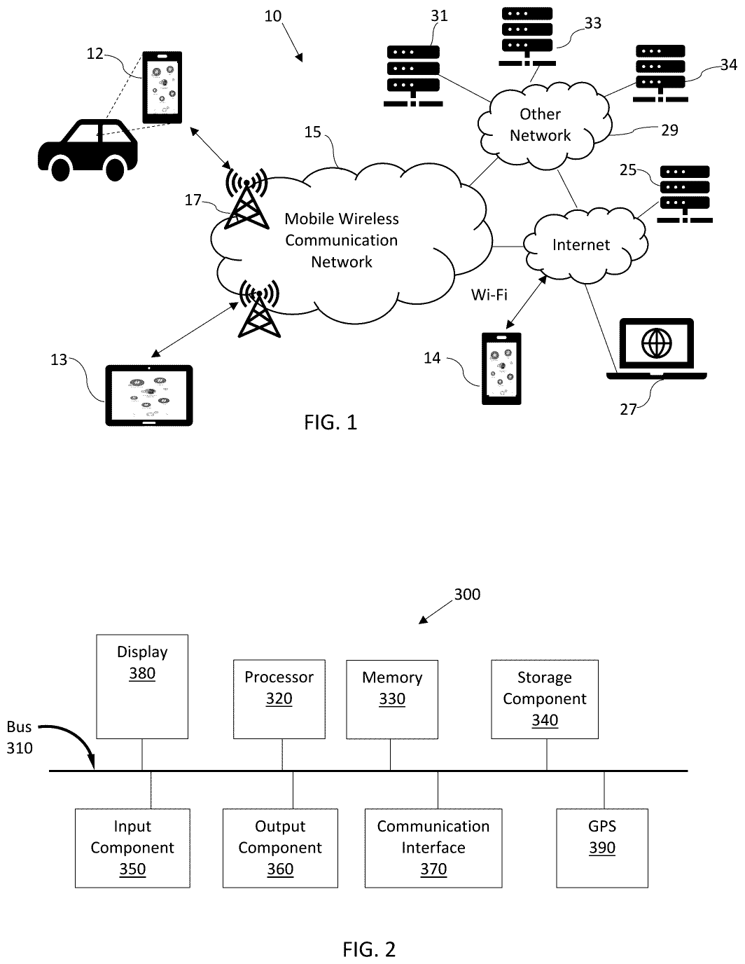

FIG. 1 illustrates a system 10 offering a variety of news story generation services, including communications in support of providing news story communications for users' mobile devices. The example shows three mobile devices 12, 13, and 14 as well as a mobile wireless communication network 15. The devices 12-14 are examples of computing devices that may execute an application configured to provide the news story generation functionality. The network 15 provides mobile wireless communications services to those devices as well as to other mobile devices via several base stations 17. The present techniques may be implemented in any of a variety of available mobile networks 15 and/or on any type of mobile devices compatible with such a network 15.

Some mobile devices 12-14 may be operative to communicate using a variety of communication networks and protocols other than those used for communication through the mobile wireless network 15. For example, as shown for device 14, at least some mobile devices are additionally or alternatively configured for data communication through a wireless communication link such as a Wi-Fi link. Mobile devices communicating through Wi-Fi communication links may access Internet-connected servers and services directly through the Internet 23, and/or access servers and services provided by a carrier of the mobile wireless network 15 via the Internet 23 and a private network 29 operated by the carrier.

The wireless mobile communication network 15 may include one or more wired and/or wireless networks or connections. For example, network 15 may include a cellular network (e.g., a long-term evolution (LTE) network, a 5G network, or a code division multiple access (CDMA) network), a public land mobile network (PLMN), a local area network (LAN) (e.g., a Wi-Fi network), a wide area network (WAN), a metropolitan area network (MAN), a telephone network (e.g., the Public Switched Telephone Network (PSTN)), a private network, an ad hoc network, a wired connection, a wireless connection (e.g., a Bluetooth connection or a near field communication connection), or the like, and/or a combination of these or other types of networks or connections.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) may perform one or more functions described as being performed by another set of devices.

The mobile devices 12-14 are capable of data communications through the network 15, and some devices may additionally be capable of voice telephone communications through the network 15.

The network 15 typically offers a variety of data services via the Internet 23, such as downloads, web browsing, email, etc. As illustrated, there is shown a laptop PC type user terminal 27 as well as a server 25 connected to the Internet 23; and the data services for the mobile devices 12-14 via the Internet 23 may be with such devices or any other type of device or system capable of data communications through the various interconnected networks. Data services for the mobile devices 12-14 can additionally be routed directly to the Internet 23 through other types of communication links, such as Wi-Fi links, in situations in which the mobile devices 12-14 are configured for communications across and have access to such links. The mobile devices 12-14 of users can receive or download software applications through the networks 23 and/or 15, such as application and/or other applications, and execute the applications written in various programming languages.

Mobile devices 12-14 can be portable handsets, smartphones, or personal digital assistants, although they may be implemented in other forms. For example, mobile devices 12-14 can be tablet computers, such as iPads, or other computing devices configured for communication through a mobile wireless communication network 15 and/or other types of wireless communication links. Program applications, including the present new story generation activities application, can be configured to execute on many different types of mobile devices 12-14. For example, a mobile device application can be written to execute on a Windows Mobile based mobile device, Android, iPhone, Java Mobile, or Blackberry based mobile device, for example.

The mobile communication network 15 can be implemented by a number of interconnected networks. Hence, the overall network 15 may include a number of radio access networks, as well as regional ground networks and a wide area network (WAN) interconnecting the regional ground networks to core network elements. Physical elements operated by one of the mobile service providers or carriers include a number of base stations represented in the example by the base stations 17. A base station 17 can include a base transceiver system, which can communicate via an antenna system at the site of the base station and over the air link with one or more of the mobile devices 12-14, when the mobile devices are within range. Each base station can be coupled to several antennas mounted on a radio tower within a coverage area.

The mobile devices 12-14 communicate over the air with a base station 17 and through the mobile wireless network 15 for various voice and data communications, e.g. services provided by an Internet-connected server 25 (e.g. a new story generation server) and/or application servers 31, 33, 34. The new story generation server may be defined by a single computer, server cluster and/or network appliance that is operated by a new story generation management company or any other industry related organization that handles new story generation management as would be appreciated by those skilled in the art.

Referring additionally to FIG. 2, an embodiment of a computing device 300, such as mobile devices 12-14 of FIG. 1, including a new story generation capability in accordance with features of the present invention will be described. FIG. 2 is a diagram of example components of a device 300. Device 300 may correspond to mobile device 12, 13 or 14. As shown in FIG. 2, device 300 may include a bus 310, a processor 320, a memory 330, a storage component 340, an input component 350, an output component 360, a communication interface 370, a display 380 and geolocation capabilities such as Global Positioning System (GPS) 390 connectivity and processing.

Bus 310 may include a component that permits communication among the components of device 300. Processor 320 is implemented in hardware, firmware, or a combination of hardware and software. Processor 320 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. In some implementations, processor 320 may include one or more processors capable of being programmed to perform a function. Memory 330 may include a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 may store information and/or software related to the operation and use of device 300. For example, storage component 340 may include various computer memory types such as RAM, DRAM, SDRAM, DDR, GDDR, HBM, ROM, PROM, EPROM, EEPROM, NVRAM a hard disk (e.g., a magnetic disk, an optical disk, a magneto-optic disk, a solid state disk, etc.), a compact disc (CD), a digital versatile disc (DVD), a floppy disk, a cartridge, a magnetic tape, an SSD, and/or another type of non-transitory computer-readable medium, along with a corresponding drive.

Input component 350 may include a component that permits device 300 to receive information, such as via user input (e.g., components of a touch screen display, a keyboard, a keypad, a mouse, a button, a switch, a microphone, etc.). Additionally, or alternatively, input component 350 may include a sensor for sensing information (e.g., a geo-location module such as a global positioning system (GPS) component, an accelerometer, a gyroscope, an actuator, etc.). Output component 360 may include a component that provides output information from device 300 (e.g., a speaker, one or more light-emitting diodes (LEDs), etc.).

Communication interface 370 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Display 380 may be a digital display, for example, an LCD, LED, plasma display, touch screen or any other digital display capable of communicating information including displaying video. Other visual displays are also contemplated including the use of ocular devices, virtual reality (VR), augmented reality (AR), and/or holographic displays, for example.

GPS 390 is a satellite navigation device, colloquially called a GPS receiver, or simply a GPS, and is capable of receiving information from Global Navigation Satellite Systems (GNSS) satellites and then calculating the device's geographical position. Using suitable software, the device 300 may display the position on a map, and it may offer routing directions. GPS 390 also provides geographical positioning information to the processor 320 for use in providing improved news story generation management services.

Device 300 may perform one or more processes described herein. Device 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, device 300 may include additional components, fewer components, different components, or differently arranged components than those shown in FIG. 2. Additionally, or alternatively, a set of components (e.g., one or more components) of device 300 may perform one or more functions described as being performed by another set of components of device 300.

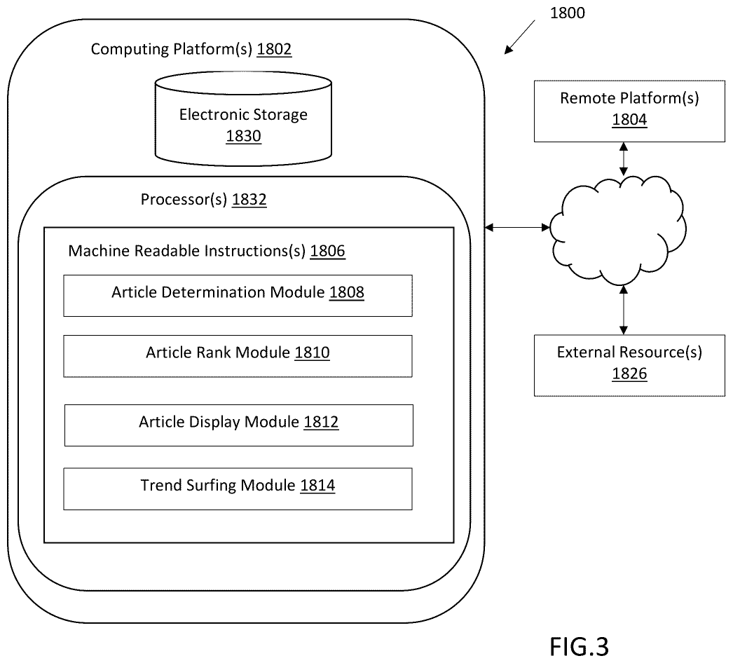

FIG. 3 is a block diagram of a computing system 1800 configured for providing the system and method for generating and sharing groups of news stories, in accordance with the example embodiments. In some implementations, computing system 1800 can include one or more computing platforms 1802. Computing platform(s) 1802 can be configured to communicate with one or more remote platforms 1804 according to a client/server architecture, a peer-to-peer architecture, and/or other architectures. Remote platform(s) 1804 can be configured to communicate with other remote platforms via computing platform(s) 1802 and/or according to a client/server architecture, a peer-to-peer architecture, and/or other architectures. Users can access computing system 1800 via remote platform(s) 1804. According to some embodiments, one or more of computing platform(s) 1802, remote platform(s) 1804, and/or other components of computing system 1800 can be the same as or similar to one or more components of the computing system 10 of FIG. 1, the computing system 300 of FIG. 2, and/or other computing resources disclosed herein.

Computing platform(s) 1802 can be configured by machine-readable instructions 1806. Machine-readable instructions 1806 can include one or more instruction modules. The instruction modules can include computer program modules. The instruction modules can include one or more of Article Determination Module 1808, Article Rank Module 1810, Article Display Module 1812, Trend Surfing Module 1814, and/or other instruction modules.

Article Determination Module 1808 can be configured to determine an article based upon a topic, at the computing system 300 or 400. For example, as discussed herein, an article may be created and/or published online via a news source or social media, for example.

Article Rank Module 1810 can be configured to generate an article rank for the article based on an age of the article, a base rate of the article, and a bonus of the article, for example. The age of the article is based upon time. The base rate of the article may be based on user actions including one or more of clicks, votes, picks, bookmarks and shares. The bonus of the article may be based upon a busyness of a respective feed related to base rates of all articles within the respective feed. User actions may include one or more of clicking on an article, upvoting an article, downvoting an article, selecting an article as a pick-of-the-day, bookmarking an article, sharing an article, or some combination of clicking on the article, upvoting an article, downvoting an article, selecting an article as a pick-of-the-day, bookmarking an article, or sharing an article.

Article Display Module 1812 can be configured to display the article within one or more feeds on the visual display based on the article rank being above a target rank. For example, the article may be displayed within a topic feed.

Trend Surfing Module 1814 can be configured to output a graphical user interface (GUI) including a trend surfing interface configured to present an arrangement of selectable topic links related to a trending topic, wherein the selectable topic links lead to articles related to the trending topic and based upon the generated article rank. Each of the selectable topic links may include a graphic related to the trending topic. A size of each graphic related to the trending topic may be scaled based upon a scaling factor related to the trending topic. Each of the selectable topic links may include an image from a latest posted article within the selectable topic link.

External resources 1826 can include sources of information outside of computing system 1800, external entities participating with computing system 1800, and/or other resources. In some implementations, some or all of the functionality attributed herein to external resources 1826 can be provided by resources included in computing system 1800.

Computing platform(s) 1802 can include electronic storage 1830, one or more processors 1832, and/or other components. Computing platform(s) 1802 can include communication lines, or ports to enable the exchange of information with a network and/or other computing platforms. Illustration of computing platform(s) 1802 in FIG. 18 is not intended to be limiting. Computing platform(s) 1802 can include a plurality of hardware, software, and/or firmware components operating together to provide the functionality attributed herein to computing platform(s) 1802. For example, computing platform(s) 1802 can be implemented by a cloud of computing platforms operating together as computing platform(s) 1802.

Electronic storage 1830 can comprise non-transitory storage media that electronically stores information. The electronic storage media of electronic storage 1830 can include one or both of system storage that is provided integrally (i.e., substantially non-removable) with computing platform(s) 1802 and/or removable storage that is removably connectable to computing platform(s) 1802 via, for example, a port (e.g., a USB port, a firewire port, etc.) or a drive (e.g., a disk drive, etc.). Electronic storage 1830 can include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 1830 can include one or more virtual storage resources (e.g., cloud storage, a virtual private network, and/or other virtual storage resources). Electronic storage 1830 can store software algorithms, information determined by processor(s) 1832, information received from computing platform(s) 1802, information received from remote platform(s) 1804, and/or other information that enables computing platform(s) 1002 to function as described herein.

Processor(s) 1832 can be configured to provide information processing capabilities in computing platform(s) 1802. As such, processor(s) 1832 can include one or more of a digital processor, an analog processor, a digital circuit designed to process information, an analog circuit designed to process information, a state machine, and/or other mechanisms for electronically processing information. Although processor(s) 1832 is shown in FIG. 18 as a single entity, this is for illustrative purposes only. In some implementations, processor(s) 1832 can include a plurality of processing units. These processing units can be physically located within the same device, or processor(s) 1832 can represent processing functionality of a plurality of devices operating in coordination. Processor(s) 132 can be configured to execute modules 1808-1824, and/or other modules. Processor(s) 1832 can be configured to execute modules by software; hardware; firmware; some combination of software, hardware, and/or firmware; and/or other mechanisms for configuring processing capabilities on processor(s) 1832. As used herein, the term “module” can refer to any component or set of components that perform the functionality attributed to the module. This can include one or more physical processors during execution of processor readable instructions, the processor readable instructions, circuitry, hardware, storage media, or any other components.

It should be appreciated that although modules 1808-1814 are illustrated in FIG. 3 as being implemented within a single processing unit, in implementations in which processor(s) 1832 includes multiple processing units, one or more of the modules can be implemented remotely from the other modules. The description of the functionality provided by the different modules described herein is for illustrative purposes, and is not intended to be limiting, as any of modules can provide more or less functionality than is described. For example, one or more of modules can be eliminated, and some or all of its functionality can be provided by other ones of modules. As another example, processor(s) 1832 can be configured to execute one or more additional modules that can perform some or all of the functionality attributed below to one of modules 1808-1814.

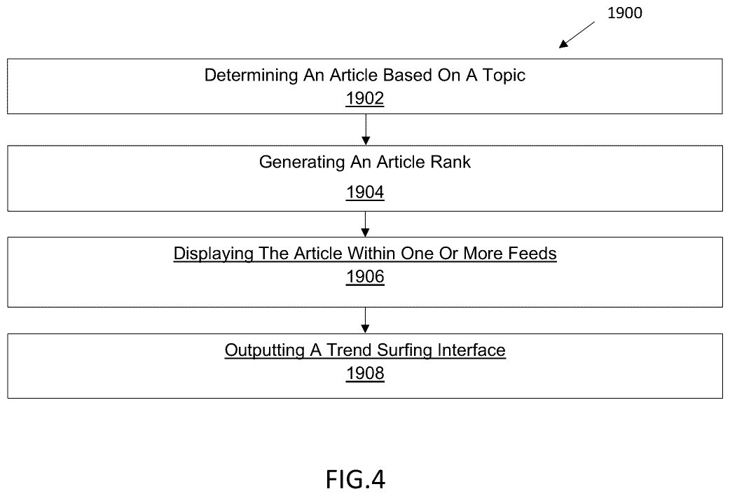

FIG. 4 is a flow chart showing functions of a method for providing the System and Method for generating and sharing groups of news stories, in accordance with the example embodiments. FIG. 4 is a flow chart showing a set 1900 of functions of that can be carried out using the computing system 10 of FIG. 1, the computing system 300 shown in FIG. 2, the computing system 1800 of FIG. 3, the computing platform(s) 1802, the remote platform(s) 1804, and/or other computing resources. A method of the example embodiments can include one or more functions of the set 1900 and/or a portion of one or more functions of the set 1900. Additionally, the order in which the functions of set 1900 are illustrated in FIG. 4 and described below is not intended to be limiting.

Accordingly, a method based on function(s) of the set 1900 can include a computer-implemented method involving a software application executed by the computing system (e.g., computing system 10 of FIG. 1), the computing system 1800 of FIG. 3, the computing platform(s) 1802, the remote platform(s) 1804, and/or other computing resources) with and/or in communication with a display screen. The software application involves graphically displaying a user interface that may include information, selectable features, updates etc.

FIG. 19 illustrates set 1900. Block 1902 includes determining an article based upon a topic. The functions of block 1902 can be performed by one or more hardware processors configured by machine-readable instructions including an Article Determination Module 1808, in accordance with the example embodiments.

Block 1904 includes generating an article rank. The functions of block 1904 can be performed by one or more hardware processors configured by machine-readable instructions including a module that is the same as or similar to Article Rank Module 1810, in accordance with the example embodiments. An article rank for the article may be generated based on an age of the article, a base rate of the article, and a bonus of the article, for example. The age of the article is based upon time. The base rate of the article may be based on user actions including one or more of clicks, votes, picks, bookmarks and shares. The bonus of the article may be based upon a busyness of a respective feed related to base rates of all articles within the respective feed. User actions may include one or more of clicking on an article, upvoting an article, downvoting an article, selecting an article as a pick-of-the-day, bookmarking an article, sharing an article, or some combination of clicking on the article, upvoting an article, downvoting an article, selecting an article as a pick-of-the-day, bookmarking an article, or sharing an article.

Block 1906 includes displaying the article within one or more feeds on the visual display based on the article rank being above a target rank. The functions of block 1906 can be performed by one or more hardware processors configured by machine-readable instructions including a module that is the same as or similar to Article Display Module 1812, in accordance with the example embodiments. For example, the article may be displayed within a topic feed.

Block 1908 includes outputting a trend surfing interface. The functions of block 1908 can be performed by one or more hardware processors configured by machine-readable instructions including a module that is the same as or similar to Trend Surfing Module 1814, in accordance with the example embodiments. For example, a graphical user interface (GUI) includes a trend surfing interface configured to present an arrangement of selectable topic links related to a trending topic, wherein the selectable topic links lead to articles related to the trending topic and based upon the generated article rank. Each of the selectable topic links may include a graphic related to the trending topic. A size of each graphic related to the trending topic may be scaled based upon a scaling factor related to the trending topic. Each of the selectable topic links may include an image from a latest posted article within the selectable topic link.

An example embodiment may flip the prior model from following people to following topics. In an example embodiment, the focus is on topics of interest. While other platforms are built with a focus on people/users, in the present approach topics may be followed. By flipping the model from following people to following topics, some embodiments may not rely on personal data and instead focus solely on the relevance of topics to provide value. Flipping the model from following people to following topics also provides a way for people to create separate and distinct feeds of topic-centric news. Additionally, in an example embodiment, influence rings may provide accountability, and reputation for the user and the source of the news as well.

In an example embodiment, an example application addresses the issue of sharing news and information in a way that provides the user with a way to view articles based on relevance. For example, an embodiment may eliminate content that may not be considered relevant. Additionally, the stress and anxiety of posting articles may be reduced by eliminating the friction of abusive behavior by having the entire experience built around topics instead of people. For example, an embodiment may remove divisive features such as comments and opinions.

An example embodiment may accomplish this by providing users a way to create “mini-hyper-niche aggregators” around any topic of interest. The “mini-hyper-niche aggregators” may be a collector of related content items that may be displayed (or that may display links to the related content items) for a small select segment of related content.

The “mini-hyper-niche aggregators” around a particular topic of interest may be referred to as a “newsroom.” Instead of following a user, e.g., “Andy,” a person may subscribe to an aggregator on a particular topic, e.g., the film industry. In this way, the person may choose to ignore the topics of mine that do not interest that person, e.g., politics or other topics that are not of interest to that person.

An example embodiment may allow for “trend surfing.” Trend surfing may provide a way to browse the relationship of topics in real-time. An example embodiment may include a visualizer that may allow for trend surfing. For example, #ETERNALS in real-time is related (in order) to the topics #MARVEL STUDIOS #CHLOE ZHAO #ANGELINA JOLIE #MARVEL

CINEMATIC UNIVERSE #RICHARD MADDEN. Tapping on one topic may refresh the visualizer around that new topic of interest and the topic's new relationships.

For example, when the mobile app opens on Trend Surfing, this is a visual way to explore the trending topics and provide a visual for users to understand how we are constantly connecting the relationship of topics to provide a browsing experience around relevance. Trend Surfing may be the base layer of the mobile application. It's the subway system underneath the feeds, connecting every Newsroom, Topic and Post through relevance of topics.

When a user closes any PANEL (the layer above the base layer) they are returned to the Trend Surfing screen, and the center Topic is based on whatever the user was looking at when they closed the PANEL. Example: A user is browsing the Topic, #BATMAN . . . if they close the panel they will return to the base layer with the center topic #BATMAN, and the top 5 topics around it will reflect the top 5 trending topics to #BATMAN. If the user is browsing a Newsroom, and then close the panel (returning to the base layer) The Topic will be based on the topic of the Newsroom. And if the user is on any other panel, then Trend Surfing will default to the #1 trending topic.

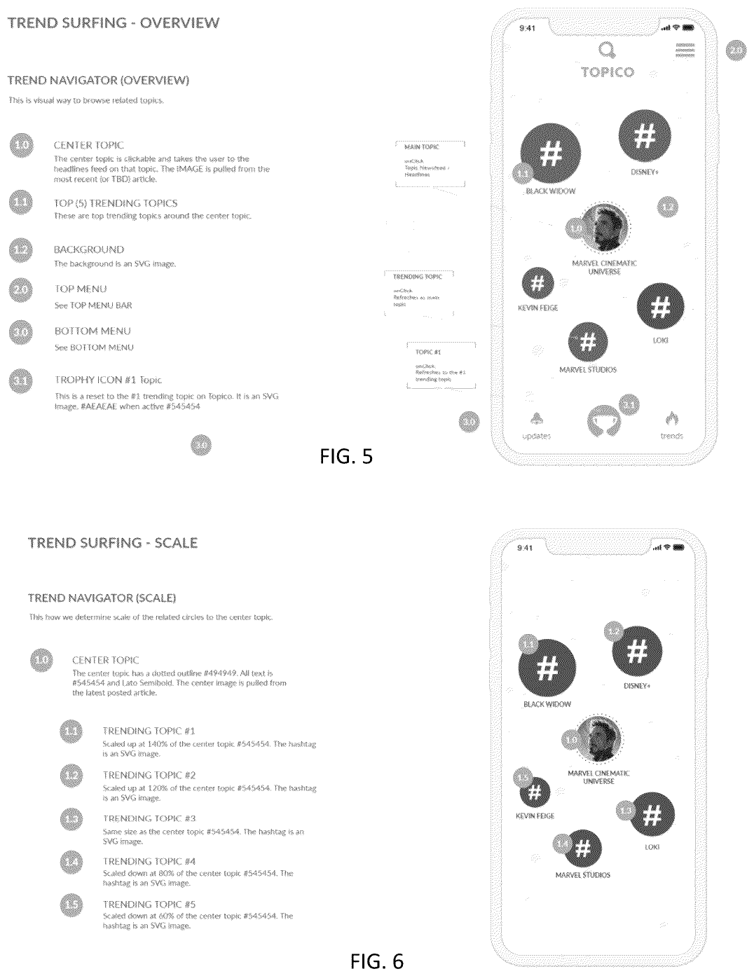

FIG. 5 illustrates an example trend surfing overview in accordance with the systems and methods described herein. As illustrated in the figure, the center topic may be clickable and may take the user to the headlines feed on that topic. One example embodiment may pull the image from the most recent article. In the illustrated example, the top five trending topics may be shown. It will be understood that other numbers of topics can be shown in other embodiments. In an example, the background may be an SVG image. The illustrated example includes a top menu and a bottom menu. In the illustrated example, an icon may be used to reset to a number one trending topic. For example, an SVG image of a trophy may be used.

FIG. 6 illustrates an example trend navigator diagram in accordance with the systems and methods described herein. In the illustrated example, this may be how the scale may be determined of the related circles to the center topic. In the example, the center topic may have a dotted outline. All text may be semi-bold. The center image may be pulled from the latest posted article. A trending topic may be scaled up. For example, the trending topic may be scaled up 140% from the center topic. The hashtag may be an SVG image. The second trending topic may be scaled up 120% of the center topic. Again, the hashtag may be an SVG image. In the illustrated example, the third trending topic may be the same size as the center topic. Again, the hashtag may be an SVG image. The fourth trending topic may be scaled down at 80% of the center topic. The hashtag may be an SVG image. The fifth trending topic may be scaled down at 60% of the center topic. The hashtag may be an SVG image. It will be understood that, while the illustrated example of the figure includes five trending topics, other examples may include fewer trending topics or a greater number of trending topics. Furthermore, it will be understood that the scaling used, e.g., 140%, 120%, 100%, 80%, and 60%, are only examples. Other scaling factors may be used in other embodiments.

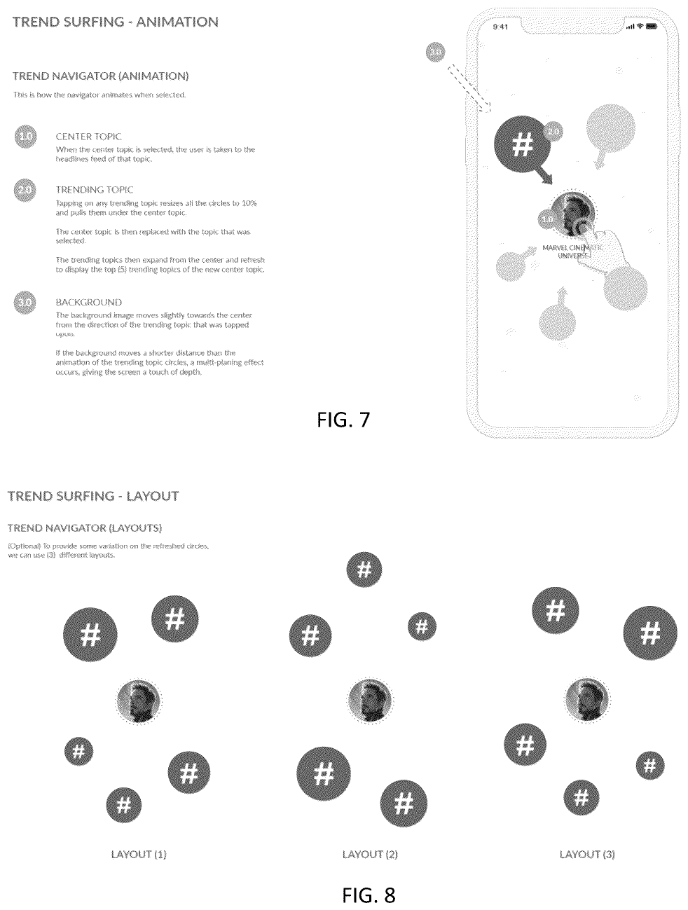

FIG. 7 illustrates another example trend navigator diagram in accordance with the systems and methods described herein. The figure illustrates how the navigator animates when selected. In the illustrated example, when the center topic is selected, the user may be taken to the headlines feed of that topic. Tapping on any trending topic may resize all of the circles to 10% and pull the circles under the center topic. The center topic may then be replaced with the topic that was selected. The trending topics may then expand from the center and refresh to display the top five trending topics of the new center topic. As illustrated, the background image may move slightly towards the center from the direction of the trending topic that was tapped. When the background moves a short distance than the animation of the trending topic circles, a multi-planing effect occurs, giving the screen a touch of depth.

FIG. 8 illustrates an example of trend navigator layouts in accordance with the systems and methods described herein. As illustrated, some embodiments may use one of three different layouts to provide some variation on the reference circles.

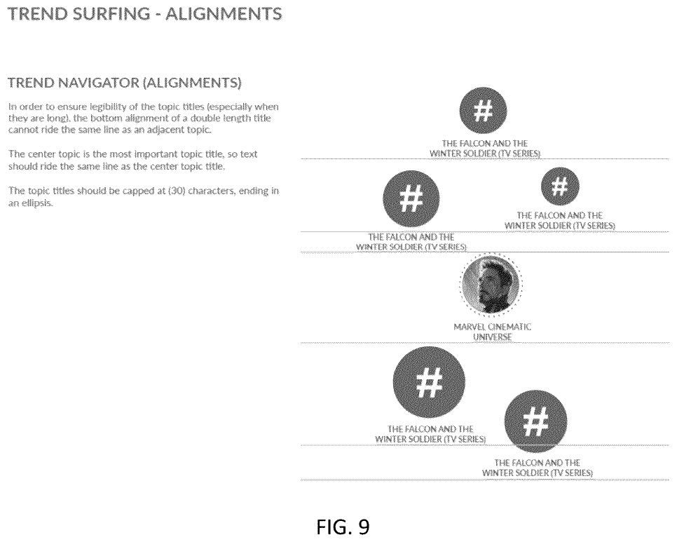

FIG. 9 illustrates an example of trend navigator alignments in accordance with the systems and methods described herein. As illustrated, to ensure the legibility of the topic titles, the bottom alignment of the double-length title may not ride the same line as the adjacent topic. In an example, the center topic may be the most important topic title, so the text should ride the same line as the center topic title; in one example embodiment. In the illustrated example, the topic titles may be capped at 30 characters and end in an ellipsis.

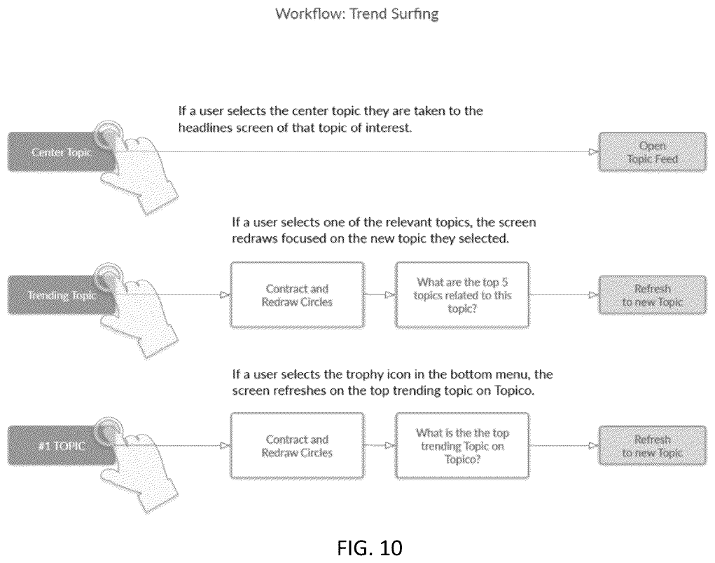

FIG. 10 illustrates an example of trend surfing workflow in accordance with the systems and methods described herein. As illustrated in the figure, when a user selects the center topic, they may be taken to the headlines screen of that topic of interest. When a user selects one of the relevant topics, the screen redraws focused on a new topic that the user may select. When a user selects the trophy icon in the bottom menu, the screen may refresh on the top trending topic.

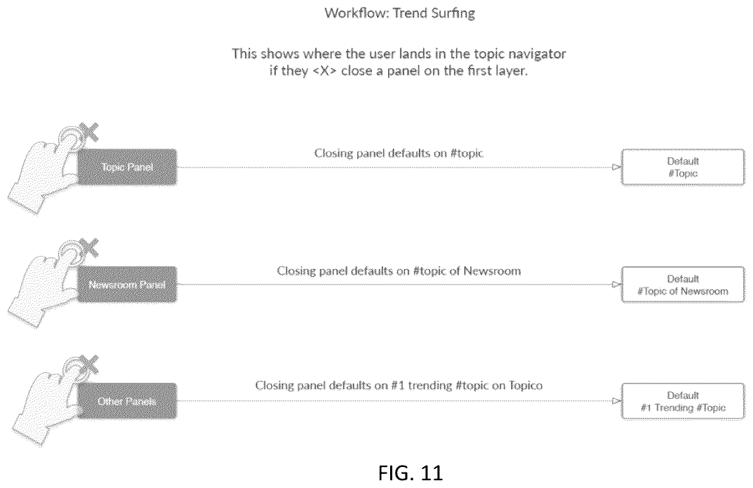

FIG. 11 illustrates another example of trend surfing workflow in accordance with the systems and methods described herein. As illustrated in the figure, the user may land in the topic navigator when they select closing a panel on the first layer. In the illustrated example, when a topic panel is closed, the user may be returned to the default topic. When The Newsroom panel is closed, the user may be returned to the topic of the Newsroom. Closing other panels may return the user to the default number one trending topic. In an example embodiment, when the Newsroom panel is closed, the user may be returned to the topic of the Newsroom. Newsrooms may be created on a topic (e.g., sports). When a user later opens a Newsroom, the user may return to the created topic of the Newsroom, e.g., sports. A reset button may be provided to return the user <back> to the previously viewed topic to help the user navigate both forwards and backward when trend surfing.

Newsrooms are ways to group relevant stories together to create a “curation” for people to subscribe to, but users may also be able to post into the platform without designating a Newsroom as well. In other words, a user can post directly to a topic as a “one-off” article. Example: A user posts an article #FISHING, but it doesn't belong in a Newsroom, they could post it with the tag and anyone viewing the topic would see that article, and if they had a fishing Newsroom they might add it to their curation. Additionally, the platform may include the ability to set notifications down to the Newsroom. Existing applications simply do a blanket notification (in other words, you get notifications on whatever the app decides might be relevant to you). Here, a user can set notifications down to just a few Newsrooms they want alerts from.

An example embodiment may show the relationship by displaying, e.g., five surrounding circles in different sizes (with the size of the circle indicating the most relevant). Other embodiments may include more circles or fewer circles. In an example, in descending order or relevance, a set of circles may include references to Donald Trump in the 2020 Presidential Election, Joe Biden's 2020 Campaign, Politics of the United States, Democratic Party of the United States. An example embodiment may do this for every topic in a system. Accordingly, some example embodiments may go beyond just what is trending today.

Some example embodiments may include “reverse timelines.” Reverse timelines may include an incorporated reverse-chronological timeline. Reverse chronological timelines (reverse timelines) may provide a way for a user to view the first articles tagged on a specific topic and browse the headlines in reverse chronological order. For example, #Covid-19 or #2021 ATTACK ON THE UNITED STATES CAPITOL may be one example of reverse-chronological timelines (or reverse timelines). Using reverse-chronological timelines (or reverse timelines), users may view a story as the story unfolded historically in chronological order, e.g., for research, historical reference, or just curiosity.

Some example embodiments may include “influence rings.” An influence ring may be a representation on a screen of a device that displays how influential the user may be on any Newsroom, topic, or news source. In an example embodiment, the perceived influence may be based on community feedback on the user's posts. In another example embodiment, the perceived influence may also be based on several factors, including if the user actually read the posted article instead of just the headlines.

Some example embodiments may include “aggregated newsrooms.” The aggregated Newsrooms (e.g., news feeds) may pull from other Newsrooms (e.g., other news feeds). In aggregated Newsrooms, an example embodiment may provide a way to create aggregate Newsrooms, e.g., a combination of many separate Newsrooms.

In an example embodiment, in a teaching setting, individual Newsrooms may be created by each student in a classroom, with the teacher owning/creating an aggregate to display all the collected articles from the class as a whole.

In another example embodiment, a news provider such as CNN may create individual Newsrooms on different topics, e.g., CNN POLITICS, CNN TECH, CNN HEALTH, and an aggregate Newsroom; CNN. The aggregate Newsroom for CNN may collect all the articles from the individual Newsrooms of CNN. Other news providers, e.g., FOX NEWS, ABC News, CBS News, NBC News, News Corp., The New York Times, or any other news provider, may create individual Newsrooms on different topics and may create an aggregate Newsrooms for that provider.

An example embodiment may have a revenue model using ad revenue. For example, part of an example revenue model may use an Ad Network that targets topics instead of people. Topic-targeted advertising may be safe and effective. Additionally, topic-targeted advertising may protect people while connecting to users in real-time at the point of interest in the topic.

An example embodiment may be a dashboard. For example, an embodiment may have a subscription dashboard. The subscription dashboard may create reports on topic data. Using topic data may be a way to track a topic, and the topic's relationship to other topics, and other sources over time. Generally, topic data may be used instead of personal data.

An example embodiment may provide for micro-transactions. For example, an embodiment may be uniquely positioned to have a micro-transaction service to charge per article rather than a full subscription service. In this way, an embodiment may sell tokens that may be passed to the news source to allow access. This may include the option for tipping. Users can purchase a batch of coins; example: 1000 coins for $10. They can freely tip articles of their choice. Sources open to tipping (example: local news) can register with the application and once a threshold is reached in tips (example: $20 or more), the source will receive funds with a nominal deducted transactional fee.

In an example embodiment, article rank may use (1) trending headlines, (2) newsroom headlines, (3) topic headlines, (4) source headlines, (5) subscriptions headlines, or some combination of trending headlines, newsroom headlines, topic headlines, source headlines, or subscriptions headlines. A topic rank may be determined using (1) trending topics, (2) newsroom trending, (3) source trending, or some combination of trending topics, newsroom trending, or source trending.

An influence ring may use a newsroom, a topic, a source, or some combination of a newsroom, a topic, or a source. In an example embodiment, a newsroom rank may use trending newsrooms, topic trending, or some combination of trending newsrooms or topic trending. In an example, embodiment related topics may use the top five trending topics related to the main topic. In another example embodiment, related topics may use the top one to ten trending topics related to a main topic. In another example embodiment, related topics may use the top ten to one hundred trending topics related to the main topic. In another example embodiment, related topics may use the top one hundred to one thousand trending topics related to the main topic. In another example embodiment, related topics may use more than one thousand trending topics related to the main topic.

In an example embodiment, inputs may include articles, actions, or some combination of articles and actions. Articles may generally have a creation time, e.g., when the article was written, when the article was published when the article was generally available to the public, or some other indicator of a date for the article. Actions may include one or more of clicking on an article, upvoting an article, downvoting an article, selecting an article as a pick-of-the-day, bookmarking an article, sharing an article, or some combination of clicking on the article, upvoting an article, downvoting an article, selecting an article as a pick-of-the-day, bookmarking an article, or sharing an article.

Users may attach articles to other articles as “relevant”. A symbol representing a linked post (from within the application) will display on a user's posted article alerting them that another user has linked an article of relevance. Tapping this symbol opens a panel that displays a relevant article feed. The owner of the post may have the ability to remove any articles they do not deem “related”. Additionally, the application preferably only allows articles—A valid post is determined to be an article if it contains; a headline, an image (optional), a creation date, and a source (url), for example. Of course, other parameters may be used instead of, or in addition to, these examples. Sources that host user-generated content may be blocked (e.g., YouTube, Reddit, and Facebook). A user is preferably blocked from posting an image onto the platform, which prevents memes, spam, and unwanted advertisements.

In an example embodiment, an article rank computation may be using at least one of (1) newsroom headlines, (2) topic headlines, (3) source headlines, or (4) trending headlines. In an example embodiment, an article may be added to a newsroom feed. Afterward, when an article satisfies a uniqueness condition, the article may be automatically added to the topic feed, to the source feed, or both the topic feed and the source feed. Independently on the feed, the article may be the same entity, defined by an article in the newsroom feed, that shares all actions and the base rate among all feeds. However, in an example embodiment, a final rank of an article may vary depending on the feed.

$${articleRank}_{feed} = \frac{baseRate + {bonus}_{feed}}{{( age + 2 )}^{1.25}} \qquad ( EQ . 1 )$$

In an example embodiment, in EQ. 1, age may be the age of the article in hours. The baseRate may represent the quality of the article without time depreciation.

baseRate=clicks+uvotes−dvotes+5·clickUvotes−5·clickDvotes+20·picks+5·bookmarks+20·shares (EQ. 2)

In an example embodiment, “clicks” may be a number of clicks on the article, e.g., over a time period or since the article's publication. In an example embodiment, all clicks from one user may be counted as one click in total. In an example embodiment, “Uvotes” may be a number of upvotes an article received, e.g., over a time period or since the publication of the article. In an example embodiment, one user may be allowed to vote for an article just once. In an example embodiment, “Dvotes” may be the number of downvotes an article received, e.g., over a time period or since the publication of the article. In an example embodiment, one user may be allowed to vote for an article just once.

It is noted that articles may not be voted up/down based on how a user “feels” about the content but rather whether it is recommended/not recommended or newsworthy/un-newsworthy.

In an example embodiment, “clickUvotes” may be a number of upvotes received from users that clicked on the article, e.g., over a period or since the article's publication. In an example embodiment, “clickDvotes” may be a number of downvotes received from users that clicked on the article, e.g., over a period or since the article's publication. In an example embodiment, “picks” may be a number of times the article was marked as the pick of the day, e.g., over a time period or since the publication of the article. In an example embodiment, “bookmarks” may be the number of times the article was bookmarked, e.g., over a time period or since the publication of the article. In an example embodiment, “shares” may be a number of times the article was shared, e.g., over a time period or since the publication of the article.

$$\begin{matrix}{bonus}_{feed} = 10 \cdot {mean}_{day} ( Δ {totalBaseRate}_{min} ) \\ = \frac{10 \cdot {\sum }_{i ∈ feed} {baseRate}_{i , T} - {\sum }_{i ∈ feed} {baseRate}_{i , T - 24}}{24 \cdot 60}\end{matrix} \qquad ( EQ . 3 )$$

In an example embodiment, a “bonus” may help new articles get close to the top. The bonus may depend on the busyness of the feed measured by the average minute increase of the sum of base rates of all articles together.

In an example embodiment, a topic rank computation may use at least one of (1) trending topics, (2), newsroom trending, or (3) source trending.

$$topicRank = {\sum }_{i ∈ topic} \frac{{baseRate}_{i}}{{( {age}_{i} + 2 )}^{1.25}} \qquad ( EQ . 4 )$$

In an example embodiment, a topic rank may be a sum of time discounted base rates of all articles with this topic. A newsroom rank computation may use at least one of (1) trending newsrooms or (2) topic trending.

$$newsroomRank = {\sum }_{i ∈ topic} \frac{{baseRate}_{i}}{{( {age}_{i} + 2 )}^{1.25}} \qquad ( EQ . 5 )$$

In an example embodiment, a newsroom rank may be a sum of time discounted base rates of all articles within this Newsroom.

In an example embodiment, an influence ring computation may use at least one of (1) newsroom, (2) topic, (3) source, or some combination of these.

$${influenceRank}_{author ⋂ feed} = {\sum }_{i ∈ author ⋂ feed} \frac{{baseRate}_{i}}{\frac{{age}_{i}}{2000} + 2} \qquad ( EQ . 6 )$$

In an example embodiment, the influence rank may be a sum of time discounted base rates of all articles posted by this author within this feed. Time discounting may be slower than in the case of articles. In an example embodiment, after one year (or some other period, e.g., from 1 month to 24 months, or longer), the contribution of the article to the author's influence may be reduced by 50%.

$${influenceRing}_{author ⋂ feed} = 10 \cdot {( \frac{{influenceRank}_{author}}{{max}_{user ∈ feed} ( {influenceRank}_{user} )} )}^{0.5} \qquad ( EQ . 7 )$$

In an example embodiment, the influence Ring value may be adjusted by a ratio of influence ranks between any user and the most influential user. In an example embodiment, distribution may be positively skewed, e.g., by the power, 0.5, which may distribute influence rings more evenly.

In an example embodiment, the platform may include the implementation of MIPs (most influential person). Based on community voting, users gain status that is measured in the influence ring, and the user with the most status is considered the MIP, or most influential person. MIPs are designated for Newsrooms, topics and sources. This status can change over time if the user does not maintain quality posted content, enabling other users to take the status of MIP away from the leader. Additionally, there may be a leaderboard on every Newsroom, topic and source to show who holds the top positions. User profiles may also acquire accomplishment badges that are displayed on their profiles. Accomplishment badges can be awarded for MIP status as well as reaching milestones (e.g., 100 posts).

In an example embodiment, related topics computation may use the top five trending topics related to the main topic. The relationRank_{topicA, topicB}—number of articles that may be associated with both topic A and topic B may be used. Most related topics to topic A may be topics with the highest relationRank_{topicA,topic}

In an example embodiment, newsrooms, e.g., “Topico Newsrooms,” may generate QR code images. For example, a particular newsroom may generate QR code image. The QR code image may be sent, e.g., to an end user. The QR code may be sent to an end user via email, text message, or some other type of electronic messaging. The QR code may be sent to be displayed (e.g., digitally, or through print). The QR code image may, when scanned, cause a device scanning the QR code to open an application (e.g., Topico App) and direct the person scanning the QR code directly to the newsroom, e.g., the particular newsroom that generated that QR code. In other words, a QR code may be affiliated with a particular newsroom. A newsroom may be affiliated with a particular QR code. The QR code may be used by an end user to get to a particular newsroom.

One or more elements or aspects or steps, or any portion(s) thereof, from one or more of any of the systems and methods described herein may be combined with one or more elements or aspects or steps, or any portion(s) thereof, from one or more of any of the other systems and methods described herein and combinations thereof, to form one or more additional implementations and/or claims of the present disclosure.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. It will be appreciated that a variety of programming languages may be used to implement the teachings of the invention as described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged.

Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A computer system to generate groups of news stories defined as feeds for respective topics, the system comprising:
one or more hardware processors, associated memory, and associated visual display configured by machine-readable instructions to:
determine an article based on a topic;
generate an article rank for the article based on an age of the article, a base rate of the article, and a bonus of the article; and
display the article within one or more feeds on the visual display based on the article rank being above a target rank;
wherein the age of the article is based upon time;
wherein the base rate of the article is based on user actions including one or more of clicks, votes, picks, bookmarks and shares; and
wherein the bonus of the article is based upon a busyness of a respective feed related to base rates of all articles within the respective feed.

2. The system of claim 1, wherein the feeds comprise newsroom headlines, topic headlines, source headlines and/or trending headlines.

3. The system of claim 1, wherein the user actions include one or more of clicking on an article, upvoting an article, downvoting an article, selecting an article as a pick-of-the-day, bookmarking an article, and sharing an article.

4. The system of claim 1, wherein the age of the article is based upon at least one of a time when the article was written, and a time when the article was published.

5. The system of claim 1, wherein displaying the article within one or more feeds includes displaying the article within a topic feed.

6. The system of claim 1, wherein one or more hardware processors, associated memory, and associated visual display are further configured by machine-readable instructions to:
output a graphical user interface (GUI) including a trend surfing interface configured to present an arrangement of selectable topic links related to a trending topic;
wherein the selectable topic links lead to articles related to the trending topic and based upon the generated article rank.

7. The system of claim 6, wherein each of the selectable topic links includes a graphic related to the trending topic.

8. The system of claim 7, wherein a size of each graphic related to the trending topic is scaled based upon a scaling factor related to the trending topic.

9. The system of claim 7, wherein each of the selectable topic links includes an image from a latest posted article within the selectable topic link.

10. A method to generate groups of news stories defined as feeds for respective topics, using one or more hardware processors, associated memory, and associated visual display configured by machine-readable instructions, the method comprising:
determining an article based on a topic;
generating an article rank for the article based on an age of the article, a base rate of the article, and a bonus of the article; and
displaying the article within one or more feeds on the visual display based on the article rank being above a target rank;
wherein the age of the article is based upon time;
wherein the base rate of the article is based on user actions including one or more of clicks, votes, picks, bookmarks and shares; and
wherein the bonus of the article is based upon a busyness of a respective feed related to base rates of all articles within the respective feed.

11. The method of claim 10, wherein the feeds comprise newsroom headlines, topic headlines, source headlines and/or trending headlines.

12. The method of claim 10, wherein the user actions include one or more of clicking on an article, upvoting an article, downvoting an article, selecting an article as a pick-of-the-day, bookmarking an article, and sharing an article.

13. The method of claim 10, wherein the age of the article is based upon at least one of a time when the article was written, and a time when the article was published.

14. The method of claim 10, wherein displaying the article within one or more feeds includes displaying the article within a topic feed.

15. The method of claim 10, further comprising:
outputting a graphical user interface (GUI) including a trend surfing interface configured to present an arrangement of selectable topic links related to a trending topic;
wherein the selectable topic links lead to articles related to the trending topic and based upon the generated article rank.

16. The method of claim 15, wherein each of the selectable topic links includes a graphic related to the trending topic.

17. The method of claim 16, wherein a size of each graphic related to the trending topic is scaled based upon a scaling factor related to the trending topic.

18. The method of claim 16, wherein each of the selectable topic links includes an image from a latest posted article within the selectable topic link.
